(19) United States
(12) Patent Application Publication
(10) Pub. No.: US 2024/0388969 A1
(43) Pub. Date: Nov. 21, 2024

(54) Accelerated Data Rate Selection in Wireless Communications

(71) Applicant: ZEBRA TECHNOLOGIES CORPORATION, Lincolnshire, IL (US)

(72) Inventors: Venkata Aneel Kumar Inuganti, Bangalore (IN); Kishore Kumar Pathankanur, Bangalore (IN); Surya Kantha Rao Kandoti, Bangalore (IN); Naga Babu Parsi, Bangalore (IN); Darpan Majumder, Bangalore (IN); Mahesh Kumar Edar, Davenagere (IN); Mahendiran Balasubramaniyam, Erode (IN); Partha P. Hazra, Bangalore (IN); Vaibhav Srinivasa, Bangalore (IN)

(21) Appl. No.: 18/199,777

(22) Filed: May 19, 2023

(51) Int. Cl. H04W 28/22; H04L 1/18; H04W 12/037

(52) U.S. Cl. CPC H04W 28/22; H04L 1/18; H04W 12/037

(57) ABSTRACT

A method in a computing device includes: establishing an association with an base station; in response to establishing the association, transmitting one or more unencrypted messages to the base station using one or more data rates selected according to an optimization sequence; receiving, from the base station, one or more acknowledgements to the one or more unencrypted messages; based on the one or more acknowledgements, selecting an active data rate; and sending encrypted data to the base station using the active data rate.

### BACKGROUND

Wireless communications, such as those conducted over wireless local area networks (WLANs), can employ a variety of modulation and coding schemes (MCS), each of which may provide a different balance between transmission data rate and reliability. The optimal MCS for a wireless device to use may vary over time, e.g., with environmental factors and/or transmission needs of an application executing at the wireless device. Discovery of an optimal MCS may interfere with ongoing communications at the wireless device.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a wireless communications system.

FIG. 2 is a sequence diagram illustrating a roaming process in the system of FIG. 1.

FIG. 3 is a flowchart of a method of accelerated data rate selection.

FIG. 4 is a sequence diagram illustrating an example performance of the method of FIG. 3.

FIG. 5 is a sequence diagram illustrating another example performance of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device, including: establishing an association with an base station; in response to establishing the association, transmitting an unencrypted message to the base station using a data rate selected according to an optimization sequence; receiving, from the base station, an acknowledgement to the unencrypted message; based on the acknowledgement, selecting an active data rate; and in response to selecting the active data rate, sending encrypted data to the base station using the active data rate.

Additional examples disclosed herein are directed to a computing device, comprising: a wireless communications interface; and a processor configured to: establish an association with an base station via the communications interface; in response to establishing the association, transmit an unencrypted message to the base station using a data rate selected according to an optimization sequence; receive, from the base station, an acknowledgement to the unencrypted message; based on the acknowledgement, select an active data rate; and in response to selecting the active data rate, send encrypted data to the base station using the active data rate.

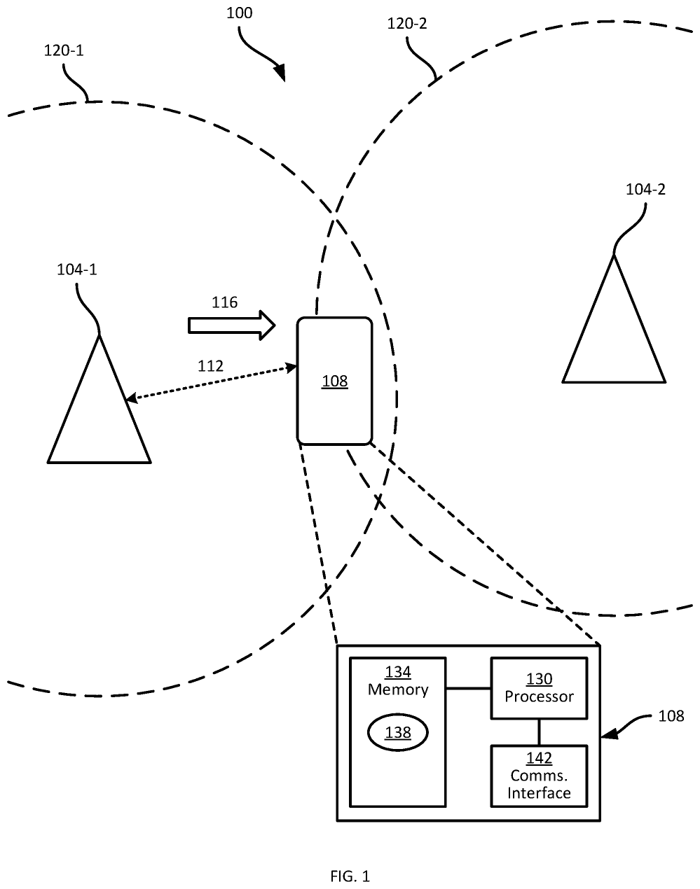

FIG. 1 illustrates a wireless communications system 100, deploying one or more wireless networks, such as wireless local area networks (WLANs) based on the Institute of Electrical and Electronics Engineers (IEEE) 802.11 family of standards (e.g., one or more Wi-Fi™ networks). The system 100 can also deploy one or more wide-area network (WAN), such as a cellular network or the like, in addition to or instead of one or more WLAN. The system 100 includes at least one base station, such as a WLAN access point (AP), a cellular base station, or the like. As shown in FIG. 1, the system 100 includes access points 104-1 and 104-2, which are referred to collectively herein as the access points 104, and generically as an access point 104 (similar nomenclature may also be used for other numbered components with dashed suffixes). The system 100 can include more than two access points 104 in other examples, or only one access point 104.

Each AP can include an enclosure housing one or more controllers, transceivers, antenna assemblies, and the like. A given network, identified by a service set identifier (SSID), can be implemented by a plurality of APs. For example, the APs 104 together can implement a WLAN with a given SSID, e.g., to extend the coverage area of the WLAN beyond the coverage area achievable with a single AP 104. Client devices within the network, such as a wireless computing device 108 (e.g., a mobile computer, a smartphone, a mobile printer, a barcode scanner, a tablet computer, or the like), can roam between the APs 104 implementing the network, e.g., according to signal strength, congestion, band preferences at the client device 108, and the like.

The client device 108 is illustrated as having established a connection 112 with the AP 104-1. As the device 108 travels, e.g., in a direction 116, the device 108 may approach an outer extent of a coverage area 120-1 (e.g., an area or volume over which the device 108 can establish a connection with the AP 104-1) associated with the AP 104-1, and enter a coverage area 120-2 associated with the AP 104-2. When the device 108 approaches the outer extent of the coverage area 120-1 and enters the coverage area 120-2, the device 108 may detect a roaming condition (also referred to as a roam trigger), such as a reduction in signal strength (e.g., a Received Signal Strength Indicator, or RSSI) from the AP 104-1. In response to detecting the roam trigger, the device 108 can collect data identifying other access points, such as the AP 104-2, to be evaluated as candidates for roaming. Each other AP 104 may have a distinct identifier (e.g., a Basic Service Set Identifier or BSSID). The identifier of each AP 104 can include a Media Access Control (MAC) address. Having collected the data identifying candidate APs 104 for roaming, the device 108 can be configured to select a destination AP 104 for roaming, according to various factors such as the capabilities supported by each AP 104, signal strength associated with each AP 104, and the like.

Certain internal components of the device 108 are also illustrated in FIG. 1. The device 108 includes a processor 130, such as a central processing unit (CPU), graphics processing unit (GPU), application-specific integrated circuit (ASIC), or the like, communicatively coupled with a non-transitory computer-readable storage medium such as a memory 134, e.g., a combination of volatile memory elements (e.g., random access memory (RAM)) and non-volatile memory elements (e.g., flash memory or the like). The memory 134 stores a plurality of computer-readable instructions in the form of applications, including in the illustrated example a wireless communications application 138 whose execution by the processor 130 configures the device 108 to perform data rate optimization functionality discussed below.

The device 108 also includes a communications interface 142, enabling the device 108 to establish connections with WLANs, such as the network implemented by the APs 104. The communications interface 142 can therefore include any suitable combination of transceivers, antenna elements, and corresponding control hardware enabling communications with the APs 104. In some examples, the application 138 resides within the communications interface 142 and is executed by a controller of the communications interface 142 distinct from the processor 130. The processor 130, memory 134, and communications interface 142 can be implemented as components of a system-on-chip (SoC) assembly, in some examples. In the discussion below, it will be understood that functions described as being performed by the device 100 or by the processor 130 can be performed by either or both of the processor 130, and a controller of the communications interface 142.

The device 108 can include further components (not shown), including output devices such as a display, a speaker, and the like, as well as input devices such as a keypad, a touch screen, a microphone, and the like.

To communicate over the WLAN implemented by the APs 104, e.g., with another computing device (not shown), the device 108 can be configured to transmit data to an AP 104, e.g., for further transmission to the other computing device. When the device 108 transmits such data, e.g., application-level data such as voice and/or video data for a voice and/or video call in progress with the other computing device, the device 108 encodes and modulates wireless transmissions to the AP 104 according to a selected one of a plurality of modulation and coding schemes (MCS), each defining parameters by which data is to be manipulated for wireless transmission. For example, in 802.11-based WLANs, the device 108 can select an MCS index value between zero and eleven, with each index value representing a different set of modulation and encoding parameters, for each frame or packet to be transmitted. Each modulation and coding scheme enables transmission of data at a certain rate (e.g., as a volume of data per second). An MCS with a higher data rate is also generally less robust to environmental interference and other factors that may disrupt wireless communications. In other words, selecting an MCS for data to be transmitted may involve balancing speed against robustness.

While transmitting data over the connection 112, the device 108 may adjust the MCS used over time, e.g., to adapt to a changing wireless environment as the device 108 moves physically, as network congestion levels change, and the like. When the device 108 roams to the AP 104-2, the MCS selected for use in transmitting data to the AP 104-1 may no longer be suitable, because the physical location, operational capabilities, and the like, of the AP 104-2 differ from those of the AP 104-1. Determining a suitable MCS to transmit data to the AP 104-2 may consume sufficient time to negatively impact ongoing application-level activities at the device 108, such as the above-mentioned voice or video call. MCS are also referred to herein as data rates for simplicity.

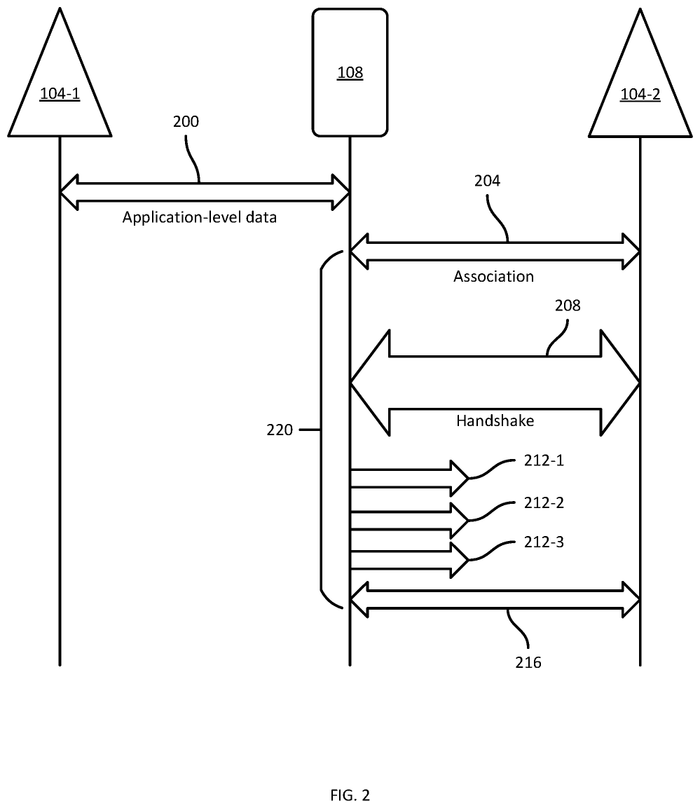

Turning to FIG. 2, an example roaming process is illustrated, in which the device 108 initially exchanges application-level data 200 with the AP 104-1, at a given MCS index (which may vary over time). When the device 108 roams to the AP 104-2, the device 108 establishes an association with the AP 104-2, e.g., via an exchange 204 that can include an association request to the AP 104-2 and an association response from the AP 104-2. Once the association is established, the device 108 and the AP 104-2 can perform a handshake 208 (e.g., a four-way handshake) to obtain encryption keys such as a pairwise transient key (PTK, e.g., for encrypting unicast traffic) and a group temporal key (GTK, e.g., for encrypting broadcast or multicast traffic). After the handshake is complete and the encryption key(s) are installed at the device 108 and the AP 104-2, the device 108 can resume transmitting application-level data, e.g., for the call mentioned above. However, the device 108 may attempt to transmit data using the same MCS as was in use for the data 200, or may default to a high data rate (e.g., an MCS index of 11), resulting in failed transmissions. For example, the device 108 may transmit first data 212-1 at a first data rate, but receive no acknowledgement from the AP 104-2. The device 108 may therefore send retransmissions 212-2 and 212-3 at successively lower data rates, but still receive no acknowledgements. The device 108 may then lower the data rate used once more, before successfully resuming the transmission of application-level data 216.

A time period 220 elapsed between establishment of the association between the device 108 and the AP 104-2, and the re-establishment of application-level traffic 216, may be sufficiently long to negatively affect time-sensitive applications such as voice and/or video calls. The device 108 is therefore further configured, as discussed below, to implement a process for accelerated data rate selection, which may reduce the time period 220 and mitigate impacts from roaming on time-sensitive applications.

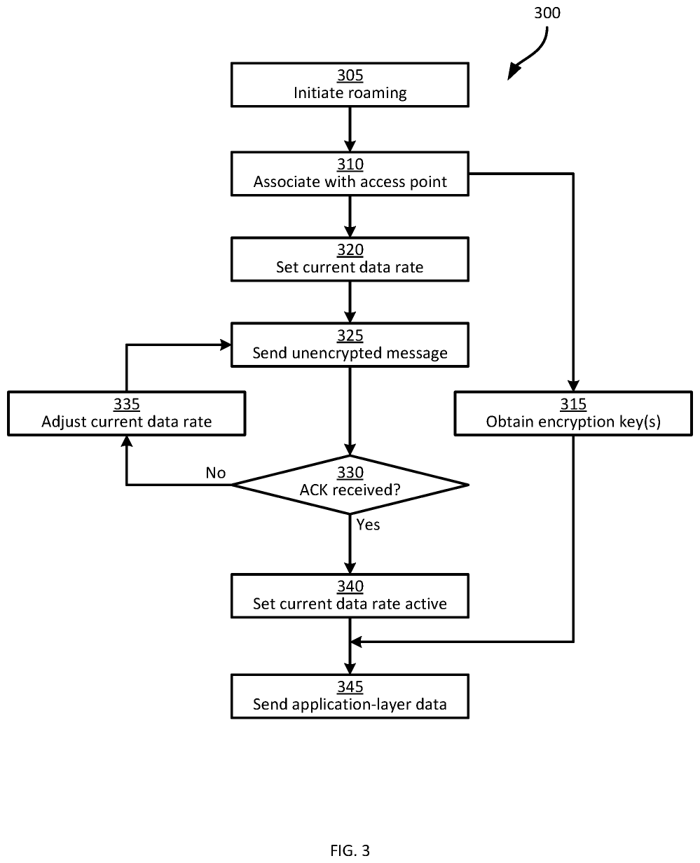

Turning to FIG. 3, a method 300 of accelerated data rate selection is illustrated. The method 300 is described below in conjunction with its example performance in the system 100, and in particular by the device 108.

At block 305, the device 108 is configured to initiate a roaming process, e.g., from the AP 104-1 to the AP 104-2 as noted earlier in connection with FIG. 1. For example, at block 305 the device 108 can detect a roam trigger, identify the AP 104-2 as a candidate for roaming, and make a decision to roam to the AP 104-2. At block 310, the device 108 is configured to establish an association with the AP 104-2. Establishing an association can include, for example, sending an association request from the device 108 to the AP 104-2, containing capabilities information such as the encryption modes and/or other features supported by the device 108. The AP 104-2 is then configured to send an association response to the device 108, e.g., containing an association identifier. The AP 104-2 can also be configured, as will be understood by those skilled in the art, to store an identifier of the device 108 (e.g., a media access control (MAC) address, or the like).

In response to establishing an association with the AP 104-2, the device 108 can be configured to perform a handshake process or other suitable mechanism to obtain one or more encryption keys, at block 315. The performance of block 315 can include, for example, a four-way handshake with the AP 104-2 to generate and store encryption keys including a PTK and a GTK, or any other suitable set of encryption keys, according to the configuration of the WLAN implemented by the APs 104 and the capabilities of the device 108.

The performance of block 315, e.g., between the initiation of the handshake and the installation of the encryption keys at the device 108, may consume a period of time between about five milliseconds and about forty milliseconds. For example, the performance of block 315 may consume about twenty milliseconds. During the performance of block 315, the device 108 does not transmit application-level data to the AP 104-2, because such data cannot yet be encrypted.

The device 108 is configured, e.g., simultaneously with at least a portion of the performance of block 315, to perform additional functionality for selecting a data rate to be used once the transmission of application-level data resumes after block 315 is complete. In other words, during the brief delay in application-level communications caused by the generation and installation of encryption keys at block 315, the device 108 is configured to at least initiate, and in some cases complete, a data rate selection mechanism. The selection of a suitable data rate contemporaneously with the generation and storage of encryption keys can reduce the total delay (e.g., the time period 220 shown in FIG. 2) before the device 108 can resume the transmission of encrypted application-level data to the AP 104-2. Further, the data rate selection process described below can mitigate the need to retransmit encrypted application-level data while data rate selection is optimized.

As described below, the device 108 is configured to select a data rate by transmitting one or more unencrypted messages to the AP 104-2, using one or more data rates selected according to an optimization sequence. Based on acknowledgements received to those unencrypted messages, the device 108 is configured to select an active data rate from the optimization sequence. When the transmission of encrypted data begins after installation of encryption keys, the active data rate is used.

At block 320, e.g., substantially simultaneously with the initiation of block 315, the device 108 is configured to set a current data rate, according to an optimization sequence. The optimization sequence defines a sequence of data rates, e.g., expressed as MCS index values. The data rates specified by the optimization sequence are used in sequence by the device 108 to transmit unencrypted messages to the AP 104-2. When a transmission yields no acknowledgement from the AP 104-2, the device 108 is configured to use the next data rate in the sequence. When a transmission does yield an acknowledgement from the AP 104-2, the device 108 is configured to set the data rate used for that transmission as the active data rate, to be used for encrypted data transmissions once block 315 is complete.

In some examples, the optimization sequence begins at a maximum data rate, e.g., MCS 11, and specifies descending data rates for use if the initial (maximum) data rate does not yield an acknowledgement from the AP 104-2. The device 108 is therefore configured, in this example, to set the current data rate to MCS 11 at block 320. At block 325, the device 108 is configured to send an unencrypted message to the AP 104-2, using the current data rate set at block 320. The unencrypted message transmitted at block 325 can be, for example, a null frame (e.g., a data frame with a header and trailer, but no payload) such as a quality of service (QOS) null frame. The use of null frames at block 325 can mitigate the impact of such transmissions on network medium usage, for example.

At block 330, the device 108 is configured to determine whether the AP 104-2 has acknowledged the unencrypted message sent at block 325. As will be understood by those skilled in the art, the AP 104-2 is configured to send an acknowledgement frame in response to messages received from the device 108. The device 108 can be configured to determine whether such an acknowledgement has been received within a timeout period of the transmission at block 325 (e.g., 1 millisecond, although a wide variety of other timeout periods can also be employed).

A negative determination at block 330 indicates that the AP 104-2 may not have received the message from block 325. When the determination at block 330 is negative, the device 108 proceeds to block 335. At block 335, the device 108 is configured to adjust the current data rate according to the optimization sequence mentioned earlier. For example, the adjustment can include decrementing the current data rate, e.g., from MCS 11 to MCS 10. Having adjusted the current data rate, the device 108 is configured to repeat block 325, transmitting an unencrypted message such as a further QoS null frame, using the current data rate (e.g., MCS 10 in this example). The device 108 then repeats the determination at block 330.

The data rate used for unencrypted messages sent at repeated performances of block 325 is therefore adjusted to provide increased reliability, at the expense of lower throughput, until the device 108 receives an acknowledgement of an unencrypted message from the AP 104-2. When the determination at block 330 is affirmative (e.g., when an acknowledgement is received at the device 108 to the message from block 325), the device 108 is configured to proceed to block 340. At block 340, the device 108 is configured to set the current data rate used at the most recent performance of block 325 as an active data rate, for use when transmission of application-layer data is resumed at block 345, following completion of block 315 (e.g., when encryption keys have been installed at the device 108 and the AP 104-2).

The device 108 is therefore configured to cycle through blocks 325, 330, and 335, reducing the current data rate with each cycle, until the AP 104-2 acknowledges an unencrypted message. In some examples, if blocks 325, 330, and 335 are repeated a sufficient number of times to traverse the entire optimization sequence (e.g., from MCS 11 down to MCS 0), and the determination at block 330 remains negative, the device 108 is configured to proceed to block 340 with the final data rate in the sequence (e.g., MCS 0) set as the active data rate.

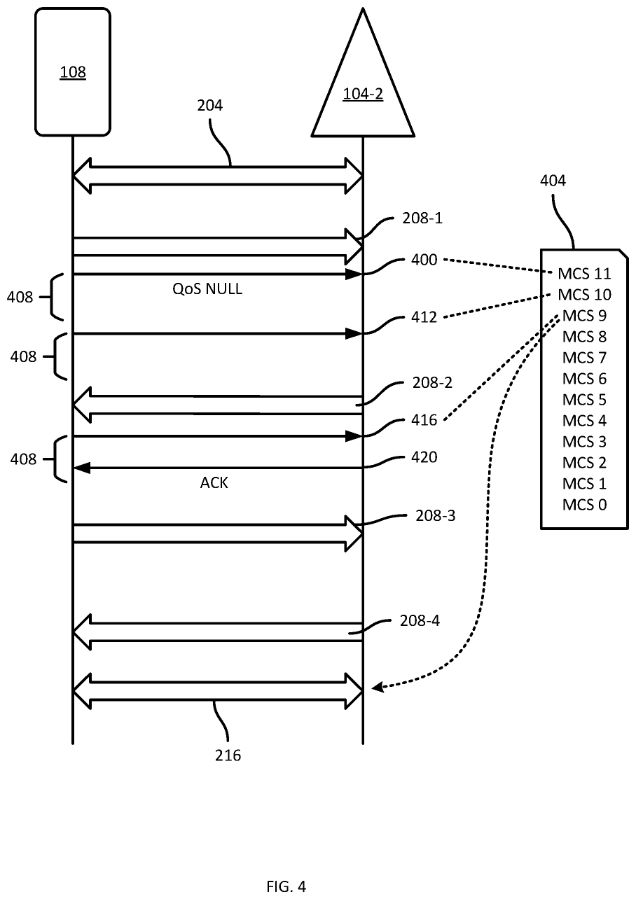

Turning to FIG. 4, an example performance of the data rate selection process provided by the method 300 is illustrated. The handshake 208 is illustrated in expanded form, e.g., including a sequence of messages 208-1, 208-2, 208-3, and 208-4 exchanged by the device 108 and the AP 104-2 to generate and install encryption keys. As will be understood by those skilled in the art, the handshake 208 may also include various acknowledgement messages, which are omitted from FIG. 4 for simplicity.

As shown in FIG. 4, contemporaneously with the handshake 208, the device 108 is configured to send a first unencrypted message 400 at block 325, using a data rate selected according to an optimization sequence 404. The sequence 404, as illustrated, descends from an initial data rate of MCS 11 to a final rate of MCS 0. That is, the sequence 404 begins with a data rate having higher throughput and lower reliability, and ends with a data rate having lower throughput and higher reliability. The sequence 404 need not be stored explicitly as illustrated at the device 108. For example, the sequence 404 can be expressed in the application 138 as instructions to begin at MCS 11, and decrement the MCS index value by one for each negative determination at block 330.

The device 100 is configured to determine, at block 330, whether an acknowledgement has been received from the AP 104-2 within a timeout period 408. As shown in FIG. 4, the AP 104-2 does not send an acknowledgement to the message 400, e.g., because the AP 104-2 did not receive the message 400 due to network congestion, environmental obstacles, or the like.

The device 108 is therefore configured to repeat block 325, after adjusting the initial data rate at block 335. In the illustrated example, the device 108 transmits a further unencrypted message 412, using a data rate corresponding to MCS 10 (e.g., decremented by one position in the sequence 404). Again, the device 108 does not receive an acknowledgement to the message 412 within the timeout period 408, and the determination at block 330 is therefore negative. The device 108 is therefore configured to adjust the current data rate again, e.g., to MCS 9 according to the sequence 404, and to send a further unencrypted message 416 to the AP 104-2. The device 108 then receives, within the timeout period 408, an acknowledgement 420 of the message 416. The acknowledgement 420 indicates that the AP 104-2 successfully received the message 416, and that the data rate used for the message 416 is therefore likely to be sufficiently reliable for transmitting data to the AP 104-2 under the current network conditions.

The device 108 can therefore store the current data rate used for the message 416 (e.g., MCS 9) as the active data rate, for use when the transmission of application-level data 216 resumes after the handshake 208 is complete. As will now be apparent from FIG. 4, the device 108 selects an optimal data rate before the handshake 208 is complete. Data rate selection therefore need not delay the transmission of application-level data once the handshake 208 is complete. In other examples, the data rate selection process discussed above may not be complete before the handshake 208, but initiating data rate selection before the handshake 208 is complete can still reduce delays in resuming the transmission of application-level data 216.

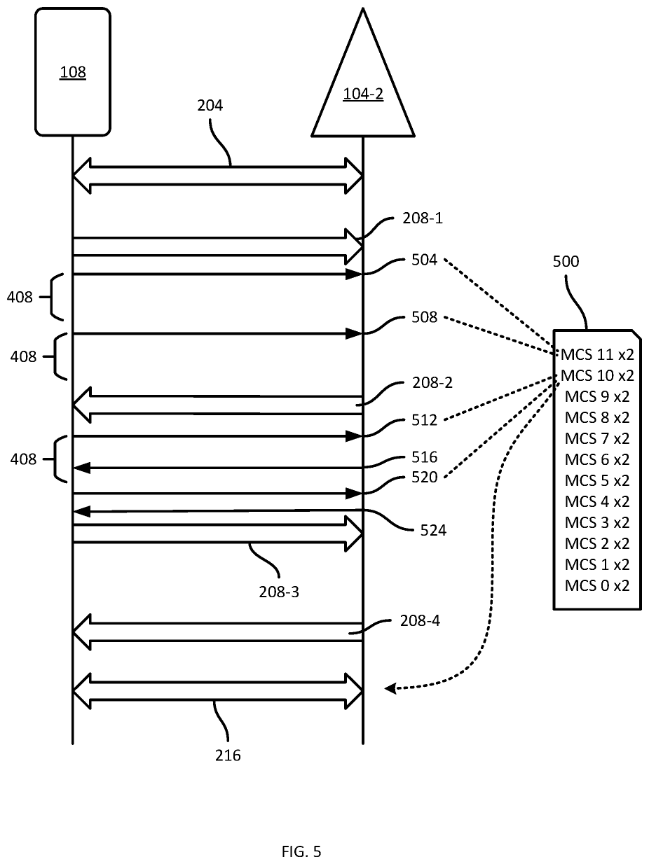

In other implementations, the device 108 can be configured to determine whether a threshold number and/or portion of acknowledgements have been received at block 330 before proceeding to block 335 or block 340. For example, turning to FIG. 5, a sequence 504 is shown in which each data rate is repeated (twice, in this example, although other numbers of repetitions can also be employed). That is, the device 108 is configured to send a first message 504 using an initial data rate (e.g., MCS 11). Before proceeding to block 335 or block 340, the device 108 is configured to await an acknowledgement of the message 504 within the timeout period 408, and to send a second message 508 at the same data rate. When neither of the messages 504 and 508 yield an acknowledgement from the AP 104-2, the determination at block 330 is negative, and the device 108 proceeds to the next data rate in the sequence 500.

In this example, the determination at block 330 may be affirmative only when both a first message 512 using MCS 10 yields an acknowledgement 52160, and a second message 520 using MCS 10 yields an acknowledgement 524. In other examples, the determination at block 330 can include whether a threshold portion of unencrypted messages at a certain data rate were acknowledged (e.g., at least half of the messages at a given data rate, or any other suitable portion).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, comprising:
establishing an association with an base station;
in response to establishing the association, transmitting an unencrypted message to the base station using a data rate selected according to an optimization sequence;
receiving, from the base station, an acknowledgement to the one or more unencrypted messages;
based on the acknowledgement, selecting an active data rate; and
in response to selecting the active data rate, sending encrypted data to the base station using the active data rate.

2. The method of claim 1, further comprising:
in response to establishing the association, initiating a handshake with the base station to obtain an encryption key;
wherein the encrypted data is encrypted using the encryption key.

3. The method of claim 2, wherein transmitting the unencrypted message is simultaneous with initiating the handshake.

4. The method of claim 1, wherein each unencrypted message includes a quality of service (QoS) null frame.

5. The method of claim 1, wherein transmitting the one or more unencrypted messages includes:
setting a current data rate according to the optimization sequence;
transmitting an unencrypted message using the current data rate;
determining whether the base station acknowledges the unencrypted message;
when the base station does not acknowledge the unencrypted message, adjusting the current data rate according to the optimization sequence, and repeating transmission of an unencrypted message using the current data rate.

6. The method of claim 5, wherein selecting the active data rate comprises, when the base station acknowledges the unencrypted message, selecting the current data rate as the active data rate.

7. The method of claim 5, wherein the optimization sequence includes a set of modulation and coding scheme (MCS) index values corresponding to data rates in a decrementing order, and wherein adjusting the current data rate includes selecting a next decremented MCS index value.

8. The method of claim 5, wherein determining whether the base station acknowledges the unencrypted message includes determining whether an acknowledgement message is received within a timeout period.

9. The method of claim 1, wherein selecting the active data rate based on the one or more acknowledgements includes determining whether a threshold number of acknowledgements was received for a current data rate.

10. The method of claim 1, wherein the base station includes a Wi-Fi access point.

11. The method of claim 1, wherein the base station includes a cellular base station.

12. A computing device, comprising:
a wireless communications interface; and
a processor configured to:
establish an association with an base station via the communications interface;
in response to establishing the association, transmit an unencrypted message to the base station using a data rate selected according to an optimization sequence;
receive, from the base station, an acknowledgement to the unencrypted message;
based on the acknowledgement, select an active data rate; and
in response to selecting the active data rate, send encrypted data to the base station using the active data rate.

13. The computing device of claim 12, wherein the processor is further configured to:
in response to establishing the association, initiate a handshake with the base station to obtain an encryption key;
wherein the encrypted data is encrypted using the encryption key.

14. The computing device of claim 13, wherein the processor is configured to transmit the one or more unencrypted messages simultaneously with initiating the handshake.

15. The computing device of claim 12, wherein each unencrypted message includes a quality of service (QOS) null frame.

16. The computing device of claim 12, wherein the processor is configured to transmit the one or more unencrypted messages by:
setting a current data rate according to the optimization sequence;
transmitting an unencrypted message using the current data rate;
determining whether the base station acknowledges the unencrypted message;
when the base station does not acknowledge the unencrypted message, adjusting the current data rate according to the optimization sequence, and repeating transmission of an unencrypted message using the current data rate.

17. The computing device of claim 16, wherein the processor is configured to select the active data rate by, when the base station acknowledges the unencrypted message, selecting the current data rate as the active data rate.

18. The computing device of claim 16, wherein the optimization sequence includes a set of modulation and coding scheme (MCS) index values corresponding to data rates in a decrementing order, and wherein the processor is configured to adjust the current data rate by selecting a next decremented MCS index value.

19. The computing device of claim 16, wherein the processor is configured to determine whether the base station acknowledges the unencrypted message by determining whether an acknowledgement message is received within a timeout period.

20. The computing device of claim 12, wherein the processor is configured to select the active data rate based on the one or more acknowledgements by determining whether a threshold number of acknowledgements was received for a current data rate.

21. The computing device of claim 12, wherein the base station is selected the group consisting of: a Wi-Fi access point, and a cellular base station.
